(19) United States
(12) Patent Application Publication
(10) Pub. No.: US 2026/0145028 A1
(43) Pub. Date: May 28, 2026

(54) TRACKING SYSTEM

(71) Applicant: Bounce Ping Pong Ltd., London Greater London (GB)

(72) Inventor: Dov Penzik, London (GB)

(73) Assignee: Bounce Ping Pong Ltd., London Greater London (GB)

(21) Appl. No.: 19/124,179

(22) PCT Filed: Oct. 23, 2023
(86) PCT No.: PCT/GB2023/052766

§ 371 Date: Apr. 24, 2025

(30) Foreign Application Priority Data
Oct. 25, 2022 (GB) 2215769.7

(51) Int. Cl. A63B 24/00; A63B 71/06; A63B 102/16; G06T 7/70; G06V 10/141

(52) U.S. Cl. CPC A63B 24/0021; A63B 71/0622; G06T 7/70; G06V 10/141; A63B 2024/0034; A63B 2102/16; A63B 2220/806; A63B 2225/74; G06T 2200/24; G06T 2207/10048; G06T 2207/30224

(57) ABSTRACT

A tracking system (17) arranged to track movement of a gaming token (13) over a gaming area, wherein the gaming token (13) moves over at least part of the gaming area during use, the tracking system (17) comprising: an infrared light source (19) arranged to illuminate the gaming area with infrared light, wherein the gaming token (13) is arranged to reflect infrared light; two or more infrared cameras (27a-c) arranged to capture images (29a-c) of the gaming area; and a processing system (31) arranged to identify the gaming token (13) in the captured images (29a-c).

The present invention relates to tracking systems arranged to track movement of a gaming token over a gaming area. The gaming token moves over at least part of the gaming area during use. For example, but not exclusively, the tracking system may be arranged to track a table tennis ball on a table tennis table. Embodiments of the present invention also relate to a method of tracking multiple objects and a method of navigating a menu.

Games such as table tennis are played widely throughout the world, by professionals, amateurs and hobby players. At all levels of the game, there is wide interest in automating scoring and arbitration of the game. A number of systems have been designed for “clean” environments such as in competition. Examples of such systems are disclosed in U.S. Pat. No. 10,909,688 and US 2020/250839, the contents of which are incorporated by reference. However, such systems struggle to track the ball in “noisy” environments such as those particularly used by hobby players.

An environment may be considered “clean” where there is an absence of surrounding distractions that may cause misidentification of the ball (such as other games on neighbouring tables, other people in close proximity to the game) and the lighting is easily controllable, bright and even.

An environment may be considered “noisy” where there are such distractions, or where ambient light is less controllable and predictable.

There is therefore a desire to make tracking systems applicable to a wider range of environments. There is further a desire to increase the accuracy of such systems, and provide a variety of different functions with automated systems.

According to a first aspect of the invention, there is provided a tracking system arranged to track movement of a gaming token over a gaming area, wherein the gaming token moves over at least part of the gaming area during use, the tracking system comprising: an infrared light source arranged to illuminate the gaming area with infrared light, wherein the gaming token is arranged to reflect infrared light; two or more infrared cameras arranged to capture images of the gaming area; and a processing system arranged to identify the gaming token in the captured images.

By using non-visible light, the gaming token can be tracked even in noisy environment, since the number of objects that the processing system will identify as the token is significantly reduced. This also enables use of tracking systems in locations with many different lighting conditions, which may be non-stable, and allows the projection of visible colours onto the gaming surface without interfering with the tracking system.

The processing system may be arranged to: identify a plurality of candidate objects in each captured image; identify the position of each candidate object in two or more captured images in a time series; and determine which of the candidate objects corresponds to the gaming token based on the change in position of the candidate objects.

The processing system may be arranged to determine which of the candidate objects corresponds to the gaming token based on the change in position of the candidate objects by: comparing the movement of the candidate objects to expected movement of the object; and identifying the gaming token as the candidate which best matches the expected movement.

The expected behaviour may include one or more of: whether the gaming token is still or stationary; the location of the gaming token; an expected direction of movement relative to the area; a speed of movement within a defined range; an expected direction of movement from a previous position; continuous movement along a path; movement along a smooth trajectory; movement along a straight line over a short period of time.

The gaming area may comprise a portion of a region illuminated by the light source and a portion of the field of view of the cameras. The processing system may ignore regions outside the gaming area. The gaming area may be divided into two or more different zones. For example, one zone may correspond to the gaming surface, and the other zone may correspond to the region of the gaming area around the edge of the surface.

The light source may provide even illumination over the gaming area.

The light source may be positioned centrally across a width of the gaming area, the width perpendicular to a longest dimension of the gaming area.

The light source may comprise an elongate body having a plurality of light emitting elements arranged along a length of the body. The length of the body may be arranged parallel to a longest dimension of the gaming area.

The light source may comprise a cover arranged to diffuse the light emitted by the source.

The gaming area may comprise a gaming surface, the gaming surface made of a material that reflects infrared light less than the gaming token

The tracking system may further comprise one or more light sources arranged to emit visible light to project visible patterns in the gaming area. This may provide information to players.

According to a second aspect of the invention, there is provided a tracking system arranged to track movement of a gaming token over a gaming area, wherein the gaming token moves over at least part of the gaming area during use, the tracking system comprising: three or more cameras arranged to capture video of a gaming surface over which the gaming token moves in three dimension, wherein the cameras are arranged above a plane defined by the surface and outside a perimeter of the surface; and a processing system arranged to determine the position of the gaming token using concurrent images from a pair of cameras, wherein the processing system is arranged to determine the position using at least a first pair of images and a second pair of images, at least one image of the first pair of images different to either one of the second pair of images, the first pair of images and second pair of images captured using the three or more cameras.

The system of the second aspect provides improved accuracy of tracking as there is less chance of not identifying or misidentifying, or mis-locating the gaming token at any particular instance. The tracking accuracy is also improved because there is less chance of the gaming token being blocked from the field of view of three cameras.

The plurality of cameras may be combined into a plurality of different unique pairs, each camera used in multiple pairs. In this case, no two pairs are identical. The position may be determined for each possible pair of cameras. In this example, where the system includes N cameras, there are N(N−1)/2 possible pairs.

Alternatively, the tracking system may comprise an even number of cameras. In this case, the position may only be determined for unique pairs such that no camera/image is used in more than one pair. For example, where the system includes N cameras, there are N/2 possible pairs.

The processing system may be arranged to determine the position of the gaming token by determining an average of the position determined using each pair of images.

The processing system may be arranged to position of the gaming token by determining a confidence score for the position determined by each pair of images, and determining the position of the gaming token based on the confidence scores.

A first camera and a second camera, arranged to capture a pair of images, may be provided on the same side of the gaming area, the side extending parallel to a longest dimension of the gaming area. A third camera may be provided on an opposite side of the gaming area to the first camera and second camera.

The first camera and second camera may be arranged on opposite sides of a centreline of the gaming area, the centreline perpendicular and midway along the side of the gaming area. The first cameras and second camera may be equidistant from the centreline of the gaming area.

At least some of the cameras may be at different heights.

There may be exactly three cameras, exactly four cameras or any suitable number of cameras.

According to a third aspect of the invention, there is provided a user interface control method comprising: projecting a user interface onto a surface of a gaming area; using two or more cameras to track the position of a physical object as it is moved over the surface by a user; and causing control of the user interface based on the tracked position.

Such a method allows a user interface projected onto a gaming area to be controlled by moving a gaming token used during gaming on the table.

Different parts of the user interface may be projected onto different parts of the surface. Moving the physical object onto areas where a part of the user interface is projected causes interaction with that part of the interface.

A predetermined movement may cause selection with or interaction with a part of the user interface. For example, movement in x-y plane may be considered menu navigation to highlight different parts of the user interface and scroll through the user interface. A predefined movement in one or more of the x, y and z direction may cause selection or interaction with a highlighted item in the user interface.

The user interface may be projected using light in first range of visible wavelengths, and the gaming surface may be illuminated in second range of non-visible wavelengths. The cameras may be particularly sensitive to light in the second range.

The objects may be tracked using the system of the first and/or second aspect.

In the first, second and third aspect, the gaming token may be a projectile that passes between two or more players during play, the players at opposite ends of the longest dimension of the gaming area. The gaming token/object that is tracked may be a ball.

The gaming area may be the surface of a table tennis table. The gaming token/object may be a table tennis ball.

According to a fourth aspect of the invention, there is provided a method of tracking a plurality of objects moving over a gaming surface, the method comprising: receiving at least two simultaneous images of a gaming area over which a plurality of objects move; dividing the gaming surface into two or more zones, each zone corresponding to an object being tracked, the objects being restricted to moving within the zone; and for each zone, determining the position of the object in the zone.

The method allows for multiple objections to be tracked during a single game, increasing the usefulness of a gaming surface. For example, the functionality of a table tennis table may be increased to play an augmented really game similar to pong. For example, the tracked objects may comprise paddles or bats that the user moves.

Each object may be constrained to move in two dimensions over the gaming surface The method may include projecting a virtual image of a gaming token intended to move between two users; and causing movement of the virtual image based on the relative positioning of the virtual image and the tracked objects.

The objects may have reflective markers affixed to them to aid their identification in the image

The gaming area may comprise a surface having markings indicating the zones.

The method may comprise: projecting images of further objects onto the gaming area; and tracking the position of the object. The method may further comprise: controlling projection of the image to simulate interaction between the tracked objects and projected images of objects.

According to various other aspects, the tracking systems and methods discussed above may be applied to various different types of object tracking.

There is provided an object tracking system comprising: a non-visible light source arranged to illuminate an area in which the object moves, wherein the object reflects the non-visible light; two or more cameras arranged to capture images of the area in the range of the non-visible light; and a processing system arranged to identify the object in the captured images.

There is also provided an object tracking system comprising: three or more cameras arranged to capture video of a surface over which an object moves in three dimension, wherein the cameras are arranged above a plane defined by the surface and outside a perimeter of the surface; and a processing system arranged to determine the position of the object using concurrent images from a pair of cameras, wherein the processing system is arranged to determine the position using at least a first pair of images and a second pair of images captured using the three or more camera.

There is further provided a user interface control method comprising: projecting a user interface onto a surface; using two or more cameras to track the position of a physical object as it is moved over the surface by a user; and causing control of the user interface based on the tracked position.

There is yet further provided a method of tracking a plurality of objects, the method comprising: receiving at least two simultaneous images of an area over which a plurality of objects move; dividing the area into two or more zones, each zone corresponding to an object being tracked, the objects being restricted to moving within the zone; and for each zone, determining the position of the object in the zone.

It will be appreciated that features discussed in relation to one aspect may be applied mutatis mutandis to any other aspect, unless mutually exclusive. Furthermore, the methods and systems of various aspects may be combined, unless mutually exclusive.

Embodiments of the invention will now be described, by way of example only, with reference to the accompanying drawings, in which:

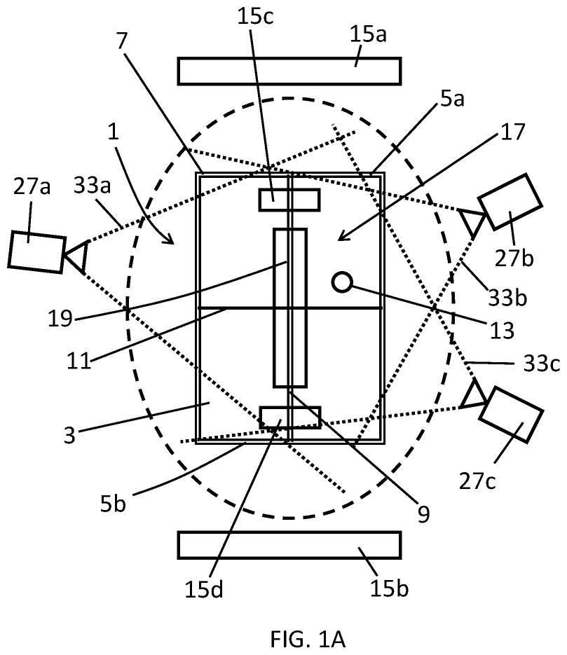

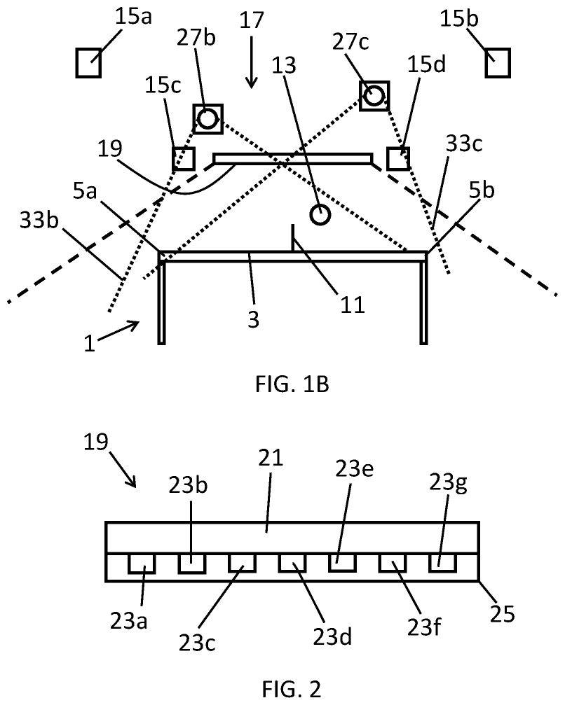

FIG. 1A illustrates a schematic top down view of a table tennis table and a tracking system for tracking a table tennis ball during play, according to various embodiments;

FIG. 1B illustrates the table tennis table and tracking system of FIG. 1A in side on view;

FIG. 2 illustrates the light source from the tracking system of FIGS. 1A and 1B;

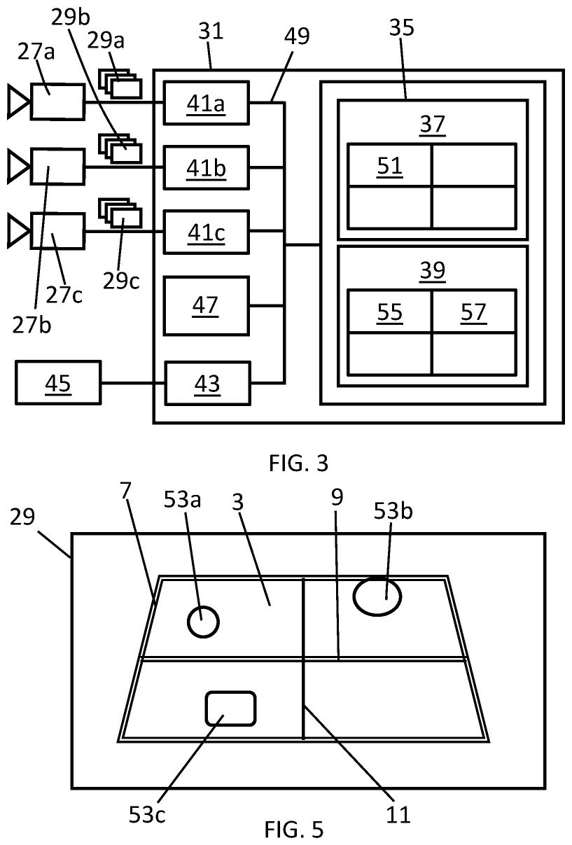

FIG. 3 illustrates the processing system from the tracking system of FIGS. 1A and 1B;

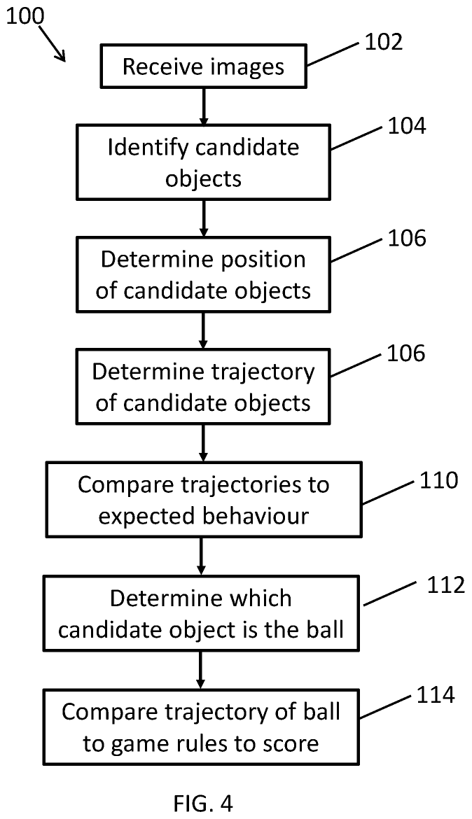

FIG. 4 shows a flow chart of a first method of tracking a table tennis ball, according to an embodiment;

FIG. 5 shows a schematic example of an image captured by the tracking system of FIG. 1A;

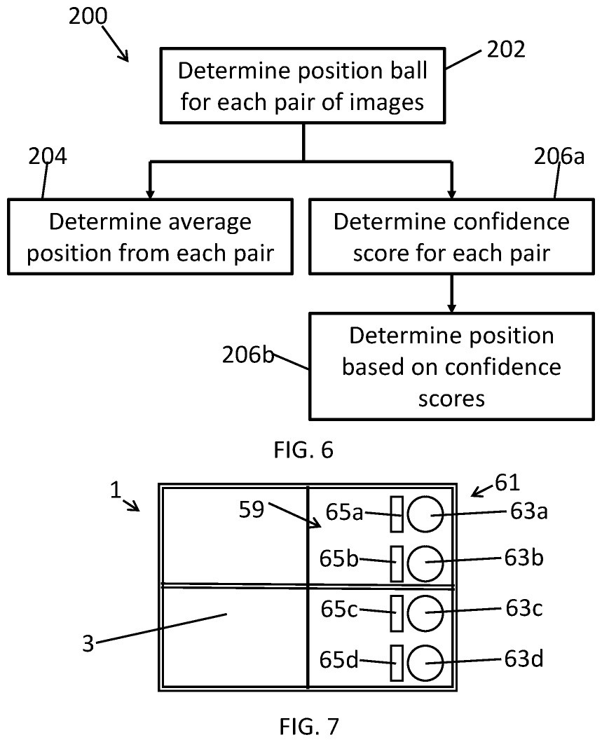

FIG. 6 shows a flow chart of a second method of tracking a table tennis ball, according to an embodiment;

FIG. 7 schematically illustrates the display of a user interface on the surface of a table tennis table;

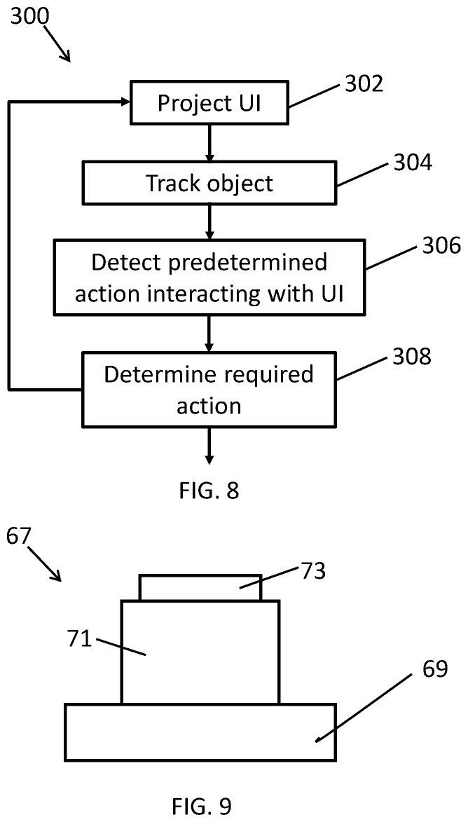

FIG. 8 shows a flow chart of a method of controlling the user interface using one or both of the tracking methods discussed above, according to an embodiment;

FIG. 9 shows a schematic example of a user object that can be tracked in an alternative game mode;

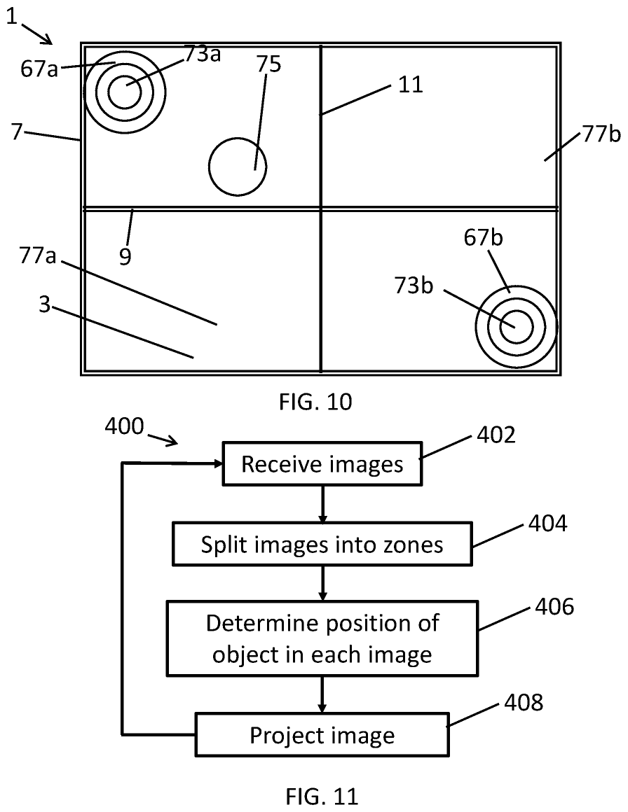

FIG. 10 shows a schematic example of the table tennis table when being used in an alternative game mode which requires multiple objects to be tracked; and

FIG. 11 shows a flow chart of a method for tracking multiple objects in an alternative game mode.

In the following description, a system for tracking a gaming object or token will be described with reference to tracking a table tennis ball on a table tennis table. However, it will be appreciated that this is simply by way of example only. The tracking system may be used to track any gaming token that is moved in any type of game or sport. For example, the gaming token tracked may be a projectile, such as a ball, shuttlecock or the like, or other tokens and gaming items, which are moving over any suitable gaming area.

FIGS. 1A and 1B schematically illustrate a table tennis table 1 in top down view and side on view respectively. The table tennis table 1 defines a playing surface 3 raised above a ground level. The surface 3 is substantially rectangular in shape having a length between two opposite ends 5a, 5b at which the players stand, and a width perpendicular to the length. The length is longer than the width.

As is known, the periphery of the surface 3 is marked with a boundary line 7 extending around the full edge of the table 1 and playing surface 3. A longitudinal centreline 9 is provided extending the length of the surface 3, midway across the width of the surface 3. A net 11 is also provided extending across the width of the surface 3, midway between the two ends 5a, 5b. In top down view, the net 11 may be considered a width-wise centreline. The longitudinal centreline 9 and net 11 thus split the playing surface into four equally sized quarters.

The surface 3 and surrounding region defines an area over which a table tennis ball 13 moves in use, when hit from end to end by players. As will be described in more detail below, visible light sources 15a, 15b, 15c, 15d are provided to illuminate the area with visible light to allow players to see. The visible light 15a, 15b, 15c, 15d may include accent/spot lights, feature lighting and diffuse lighting, and/or may provide for projection of information, patterns and the like.

A tracking system 17 is provided to automatically track the ball 13 and score/adjudicate the game between the players. The tracking system 17 is based on detecting of non-visible light reflected by the ball 13. In the example below, infrared light is used but other wavelengths of non-visible light may also be considered.

The tracking system 17 includes an infrared light source 19 positioned above the table 1. The output 19a from the light source 19 is shown by long dashed lines. The size and shape of the light source 19 is selected so that the infrared illumination is relatively even and consistent over the gaming area, such that variation in the infrared light intensity over any regions where the ball 13 is expected to be detected is below a threshold deviation.

The total output area 19a of the light source may be larger than the gaming area, however any areas of low, inconsistent or unreliable infrared light, or hot spots are away from the gaming area.

FIG. 2 shows one possible example of the light source 19. In this example, the light source 19 has an elongate body 21 or substrate that extends along a length that is at least an order of magnitude larger than its widths. An array of light emitting elements 23a-g are mounted in an array along the length of the body 21. A diffuser 25 is then provided over the light emitting elements 23a-g to provide even, uniform lighting.

The light source 19 is positioned with the elongate length of the body extending along the longitudinal centreline 9 of the surface 3, and is also centrally located along the length of the surface 3.

In one example, the infrared light source 19 may be an Effi-Flex adjustable beam angle LED bar provided by Effilux™. The light source may be 635 mm long, with 15 LEDs evenly spaced over the length, and an opaline diffuser.

The ball 13 is made from or coated with a material that reflects infrared light. It may be that the ball may selectively reflect infrared light compared to other materials. The surface 3 of the table 1 is, however, coated in a material that is non-reflective for infrared light. Therefore, when infrared images of the gaming area are captured, the ball is easy to isolate and identify. In one example, the surface 3 of the table may be made from a high-density laminated resin, with a mat top having a 3% GU (Gloss Unit) finish (±1%). The laminate may be between 4 mm and 9 mm thick. In one example, the laminate may be kraft paper impregnated with phenolic resin and a surface ‘decorative’ layer impregnated with thermoset resin (also known as aminoplastes). The laminate may be 60-70% wt paper and 30-40% wt thermoset resin (phenolic resin for inner layers and melaminic resin for outer layers)

Examples of existing table tennis tables with a suitable finish include Cornilleau™ full Mat Top models, which are normally used for reduced glare in outdoor settings.

The boundary lines 7, longitudinal centreline 9 and a top of the net 11 may also be coated with or formed by a material that selective reflects infrared light compared to other materials to allow the playing area to be identified in images captured.

The tracking system 17 includes a number of infrared camera 27a-c positioned around the table 1. FIGS. 1A and 1B show the field of view 33a, 33b, 33c of each camera 27a-c as short dashed lines. As can be seen, the cameras 27a-c are positioned such that the full gaming area is within the field of view of the cameras 27a-c. Each camera captures a series of images 29a-c of the playing area. The images 29 are fed to a processing system 31 for analysis to identify the ball 13 in the images 29 and track the movement of the ball.

FIG. 3 schematically illustrates the processing system 31 in more detail. The processing system 31 includes a memory 35 having a programme storage portion 37 and a data storage portion 39. The programme storage 37 comprise computer programme instructions that cause operation of the processing system 31. The separate computer programme instructions may be considered as separate modules. The data storage portion 39 contains various reference data and other stored information as required.

The processing system also includes drivers 41a-c for operating the infrared cameras 27a-c. In the example shown, a separate driver is provided for each camera 27a-c, however, it will be appreciated that multiple cameras may be connected to a single driver 41.

An input/output interface 43 is also provided, for receiving user instructions/input and providing data output to a user input/output device 45. The user input/output device 45 may be a single unit, such as a touch screen device, or may comprises multiple units, such as a display, projector, keyboard, mouse and the like.

The processing system 31 also include a processor 47 arranged to execute the computer programme instructions stored in the programme storage portion 37 of the memory 35. The memory 35, drivers 41a-c, input/output interface 43 and processor are all connected to each other through a system bus 49.

The computer programme instructions may be delivered to memory 35 in any suitable manner. For example, the program code may be installed on the device from a CDROM; a DVD ROM / RAM (including −R/−RW or +R/+RW); a separate hard drive; a memory (including a USB drive; an SD card; a compact flash card or the like); a transmitted signal (including an Internet download, ftp file transfer of the like); a wire; etc.

The processor 47 may be any suitable controller, for example an Intel® X 86 processor such as an 15, 17, 19 processor or the like.

The memory 35 could be provided by a variety of devices. For example, the memory 35 may be provided by a cache memory, a RAM memory, a local mass storage device such as the hard disk, any of these connected to the processor 47 over a network connection. The processor 47 can access the memory 35 via the system bus 49 and, if necessary, through a communications interface such as WiFi, 4G and the like, to access program storage portion 37 of the memory 35.

It will be appreciated that although the processor 47 and memory 35 have been described as single units, the functions of these elements may be distributed across a number of different devices or units. Furthermore, the processing steps discussed below may all be performed at the same locations or two or more different locations.

The operation of the processing system 31 will now be discussed with reference to the flow chart shown in FIG. 4. FIG. 4 shows a first method 100 of tracking a gaming token, such as a table tennis ball 13 using images 29a-c captured by the infrared cameras 27a-c. The method 100 is implemented by a ball tracking module 51 in the programme storage portion 37 of the memory 35. The ball tracking module 51 is based on the systems described in U.S. Pat. No. 10,909,688 and US 2020/250839, adapted for use in a noisy environment.

At a first step 102, infrared images 29a-c are received from the cameras 27a-c. A time series of images 29 is received from each camera 27a, 27b, 27c, each image 29 with an associated time stamp.

FIG. 5 shows an example of a captured image 29′. At a second step 104, each image 29a-c is processed to identify one or more candidate objects 53a-c that the tracking module considers may be the table tennis ball 13.

As discussed above, the ball 13, and the lines 7, 9 and net 11 of the table tennis table 1 are highly reflective for infrared light, compared to other objects in the surrounding environment.

Candidate objects 53a-c are identified as regions with an approximate shape and size matching that expected for the ball 13, and with sufficient measured reflected intensity.

To ensure a clean image, the surface 3 of the table, and other objects in the surrounding area (such as table tennis paddles) are made from objects which do not reflect infrared light, or only reflect low levels of infrared light. Similarly, the visible lights 15a-d are selected with no or negligible infrared output. This simplifies processing by ensuring high contrast between the ball 13 and the background, and reduces the potential number of candidate objects. The even illumination ensures that the ball 13 is equally likely to be found in any area of the image 29.

At a third step 106, the position of the candidate objects 53a-c is determined by analysis of each image 29a-c. The position is determined in the frame of reference of the table 1. The position is able to be determined based on triangulation using the known position of the cameras 27a-c and table 1, and the lines 7, 9 and net 11 in the images 29. By processing two or more concurrent images, captured at the same time instance, the position of each candidate object 53a-c in three dimensions can be found.

In order to ensure the images used are concurrent, the clocks (not shown) of the cameras 27a-c, used to apply the timestamp to the image 29a-c (i.e. the time at which the image is captured) should be synchronised. In one example, all three camera clocks may be synchronised to a clock of the processing system 31. However, it will be appreciated that any suitable lead clock may be adopted. Where the cameras 27a-c connected to the drivers 41a-c by cables, synchronisation is straightforward. However, it will be appreciated that the cameras 27a-c may also be connected to the drivers 41a-c by wireless connections. In this case, various wireless communication protocols, which allow for clock synchronisation, may be used. For example, the Precision Time Protocol (PTP) defined in the IEEE 1588 standard may be used.

The trajectory along which each candidate objection 53a-c moves is determined for a period of time, at a fourth step 108. This uses the current images, and the previous images in the time series. The trajectory of each candidate object 53a-c is then compared to the expected behaviour of the ball at step 110, and a determination of which candidate object 53a-c is most likely to be the ball 13 is made at step 112.

A ball behaviour module 55 is provided in the data storage portion 39 of the memory 35. This includes various expected characteristics of how the ball 13 will move during a game of table tennis. By comparing the trajectory of each candidate objection 53a-c, the ball 13 can be identified.

Various criteria may be applied in the ball behaviour module 55, based on one or more of the following expected behaviours:
The ball 13 is expected to move during gameplay. Therefore, stationary objects may be discounted.
The ball is not expected to be in certain areas of the field of view of the cameras 27a, 27b, 27c, and so certain areas of the image may be ignored. Areas where there are a large number of false candidates may also be ignored.
The ball 13 is expected to move in a general direction from end to end 5a, 5b.
The speed of movement is expected to fall within a predefined range.
The ball 13 is expected to follow a particular path from a point at which it changes direction, based on the direction in which it is hit, spin and the like.
The ball 13 is unlikely to include significant changes away from a smooth trajectory, based on the previously detected position.
The ball 13 is expected to follow a continuous path without jumps in position.
The ball 13 is expected to move in a straight line over a short period of time.

In some examples, one or more of these criteria may be applied by looking at the current frame and a number of past frames. For example, the past ten frames may be considered (although the number of frames may be any number of frames).

The candidate object 53a-c that best matches these criteria, and also other criteria such as shape, size and the like, is identified as the ball 13. In one example, a confidence score (the likelihood that the candidate is the ball 13) may be associated with each candidate object 53a-c and the candidate with the highest score identified as the ball.

In an optional final step 114 in the method 100, the movement of the candidate object 55a-c identified as the ball 13 can be compared to a rules file 57 stored in the data storage portion 39 of the memory 35, to determine when a point is scored. The score can be tallied and presented to users through the input/output device 45.

During a game, various situations may be identified from analysis of the behaviour of the ball 13. These may also be included in the rules file 57. For example, after a point is scored, the method may continue to identify and track objects, but not restart the step of scoring the game until the movement of the ball 13 matches that expected of a serve.

In the system shown in FIGS. 1A and 1B, three cameras 27a, 27b, 27c are illustrated. However, from the above description, it will be apparent that only a pair of cameras 27a, 27b, 27c is required for performing the method 100 of FIG. 4. Any two of the camera 27a, 27b, 27c shown in FIGS. 1A and 1B may be used in the method 100. For example, the two cameras 27b, 27c on the same side of the table as each other may be used. It will also be appreciated that the tracking system 17 may be provided with only the two cameras 27b, 27c that are used.

In other examples, the tracking system 17 may be provided with three or more cameras 27a, 27b, 27c. FIG. 6 illustrates a flow chart of a second method 200 of tracking a gaming token, such as a table tennis ball 13 using images 29a-c captured by the infrared cameras 27a-c. Like the method 100 shown in FIG. 4, the second method 200 is implemented by the ball tracking module 51 in the programme storage portion 37 of the memory 35.

When there are three different cameras 27a, 27b, 27c, there are three possible pairs of cameras that may be used to determine the position of the ball 13—the first camera 27a and the second camera 27b may form a first pair, the second camera 27b and the third camera 27c may form a second pair (the pair on the same side as the table) and the first camera 27a and the third camera 27c may form a third pair.

In a first step 202 of the second method 200, the position of the table tennis ball 13 is determined for each possible pair of cameras 27a, 27b, 27c and images 29a, 29b, 29c. The position for each pair of cameras 27a, 27b, 27c and images 29a, 29b, 29c is determined in the same way as the first method 100 (i.e. identifying candidate objects, determine position of candidate objects, determine which candidate object is the ball 13) The final position of the table tennis ball 13 may then be determined in any one of a number of different ways.

In a first embodiment, the final position of the table tennis ball 13 is determined in a second step 204a, by determining an average of the position determined by each pair of cameras 27a, 27b, 27c and images 29a, 29b, 29. The average is then taken as the position of the table tennis ball 13.

In a second embodiment, a confidence score is determined for the position of the ball 13 determined by each pair of images 29a, 29b, 29c, at a first step 206a. The confidence score may be based on a number of factors, including, for example, the number of candidate objects identified in a pair of images, how closely the movement of the candidate object matches the expected behaviour from the ball behaviour module 55, how closely the candidate object matches the expected size/shape of the ball 15. Various other factors will also be apparent to the person skilled in the art.

At a second step 206b, the position with the highest confidence score is selected as the position of the table tennis ball 13.

In yet further examples, the position of the ball may be determined using a combination of the confidence scores and averaging. For example, the average may be calculated using only candidate objects or positions with confidence scores above a threshold, or where there are a number of pairs, only a set of predetermined size may be used in the average, the set selected as the positions with the highest confidence value. In examples where only one pair of images 29a, 29 29c meets the threshold, this may be determined as the position without taking an average.

It will be appreciated that the method 200 shown in FIG. 6 may be used with any number of cameras 27a, 27b, 27c arranged in any number of pairs. For example, where there are N cameras, there may be N(N−1)/2 different unique pairs that may be used.

In some examples, every possible unique pair may be used. In other examples, a subset of the possible pairs may be selected for use, based on position and orientation of the cameras, and the like. The predetermined pairs may overlap, so that some or all of the images 29a, 29b, 29c from the cameras 27a, 27b, 27c may be used in more than one pair, or the pairs may not overlap so that each image 29a, 29b, 29c from each camera 27a, 27b, 27c is only used once.

In one example, a first pair of cameras 27a, 27b, 27c may be provided on a first side of the tale 1, and a second pair of cameras 27a, 27b, 27c may be provided on the opposite side. Each pair may be considered a separate pair of cameras for the method 200. As a minimum only two pairs of cameras/images may be used, but any number can, in theory, be used.

In the method 100 disclosed with respect to FIG. 4, the gaming area is illuminated with infrared light, and infrared cameras used to track the ball 13. It will be appreciated that the method 200 of FIG. 6 is applicable to this scenario, but it is also equally applicable to the use of cameras detecting visible light, or any other wavelength of light. Provided the position of the ball 13 is determined form the pair of images in some way, by two or more pairs of cameras 27a, 27b, 27c, the images 29a, 29b, 29c can be captured at any wavelength.

In some examples, cross-processing of candidate objects from at least two different pairs of cameras 27a, 27b, 27c can also be used to determine which of the identified candidate objects may be the table tennis ball 15.

In the examples discussed above the images 29a-c from the camera are simply divided into a first area which is used for tracking the objection (likely to be the gaming area), and a second area which is ignored. In some examples, the area in which the object is tracked may be sub-divided into two or more sub-zones. For example, the first zone may correspond to the gaming surface 3 of the table 1, and a second zone corresponding to a “skirt” zone around the table 1. This may allow, for example, better tracking when the ball 13 hits the edge of the table 1 and changes direction.

An interactive user interface 59 may also be implemented using the tracking methods 100, 200 and tracking system 17 discussed above. This may be used to provide the input/output interface 43 as discussed above.

FIG. 7 illustrates a schematic example of an interactive menu 61 projected onto the gaming surface 3 of the table tennis table 1.

The menu 61 is projected by one or more of the visible light sources 15a-d shown in FIG. 1A, and may include one or more menu areas 63a-d which a user interacts with the navigate through the menu and one or more information areas 65a-d which provide output to the user. The information areas 65a-d may be associated with the menu areas 63a-d, for example they may provide information on the outcome for selecting each menu area 63a-d. Alternatively, the menu areas 63a-d may include the information, and the information areas may be separate.

The menu 61 may provide for limited control of the tracking system 17, to allow users to, for example, start a new game, enter their name for a score board, select different game modes, select optional rules and the like.

Whilst FIG. 7 shows four menu areas 63a-d and four information areas 65a-d, this is by way of example only, and any number of areas 63, 65 may be provided.

FIG. 8 schematically illustrates a method 300 of controlling the user interface 59 shown in FIG. 7.

At a first step 302, the user interface 59 is projected ono the gaming surface 3. Projection of the user interface 59 may be triggered in a number of different scenarios. For example, when the system detects a game has finished, or when an external control/management system instructs the menu 61 to be displayed.

At a second step 304, the position of an object on the table is tracked. The object is employed by the user to interact with the menu 61, and is tracked using the same methods 100, 200 as discussed above.

As the object is moved in the x and y direction of the gaming surface 3, this corresponds to the user selecting different parts of the menu 61. Optionally, the active part of the menu 61, which the object is positioned over may change in appearance to indicate the current active portion. In a third step 306, the user performs a predetermined action to indicate they wish to interact with that part of the menu 59. Any suitable predetermined movement in one or more of the x, y and z directions may be used as the predetermined action. For example, moving the object towards or away from the surface 3, moving the object in a predefined pattern, or any other predefined movement patterns may be used.

After the user interacts with the part of the menu, a determination is made at step 308 as to the action required. This may involve, for example, changing a physical or electronic parameter of the tracking system 17, or table 1, selecting a particular game mode or expected ball behaviour, or moving between different layers of the menu 61.

In one example, the table tennis ball 13 or another gaming projectile may be used as the object for interacting with the menu 59. In other examples, any suitable object, point or the like may be used. In yet further examples, a user's hand may be used to track interaction with the menu. Movement of the hand, for example making a fist, may be used to interact with parts of the men 61.

The object may also be tracked to allow input of handwriting.

It will be appreciated that during gameplay, when the interactive menu is not required, part of the user interface may be displayed. For example, a name of the players and a live score may be displayed.

In some examples, during game play, a single menu area may be provided on the gaming surface 3 to allow a user to open the menu 61, or the menu (or a single button to open the menu) may be provided if the tracking system detects that the ball has not moved for a predetermined period.

The examples discussed above have been described in relation to a table tennis table 1. However, it will be appreciated that the same tracking system 17, tracking methods 100, 200 and user interface control method 300 may be used on any suitable surface, with any suitable gaming projectile or object being tracked. Different expected behaviour modules 55 and rules files 57 may be provided for different uses. In examples where a single surface 3 can be used for multiple different games, the menu 61 can be used to select the desired game, and this will cause selection of the relevant expected behaviour module 55 and rules file 57 from a plurality of available expected behaviour modules 55 and rules files 57.

In some examples, it may be necessary to track multiple objects. For example, in some embodiments, the tracking system 17 may project a virtual projectile onto the gaming surface 3 through the visible light sources 15. Each user may have a paddle, disc or other object which interacts with the virtual projectile to hit the virtual projectile between different ends of the table. This may be useful for games such as pong or air hockey.

A game rule file may be provided that governs the physics/equations of motion of how the virtual projectile interacts with the users'items. This may control the projection of the virtual projectile. The virtual projectile may be constrained in two dimensions (i.e. only on the surface of the tale).

In order to control the projection of the virtual projectile, the tracking system must know the position of the two users'items. FIG. 9 illustrates a schematic example of one of the user items 67.

The user item 67 has a base 69 which rests on the gaming surface 3, a handle 71 which is held by the user and a reflective tag or marker 73. The reflective tag 73 is positioned such that it is visible to the cameras 27a, 27b, 27c when held by a user. The reflective tag 73 is selected to reflect whichever light is used by the method for tracking the objects, discussed below. For example, if the method of FIG. 1 is used, the reflective tag 73 may reflect infrared light. However, any suitable tracking light may be used.

FIG. 10 illustrates the table tennis table 1 shown in FIG. 1, with two user items 67a, 67b for use in a virtual projectile based game. Each user item 67a, 67b has a corresponding reflective tag 73a, 73b. The virtual projectile 75 is also shown projected on the surface 3 of the table 1.

As discussed above, the boundary line 7, centre line 9 and net 11 divide the table into a number of different zones. For example, separate zone 77a, 77b may be provided on either side of the net 11.

Due to the net 11, and also the rules of the game, the user items 67a, 67b are constrained to move within one zone 77a, 77b each. In some embodiments, the user items 67a, 67b may be constrained to move only along a single line parallel to the net 11. The user items 67a, 67b may also be constrained to move in only two dimensions, over the surface 3 of the table 1, or even one dimension along the surface 3 of the table 1 (for example along a line across the width of the surface 3).

FIG. 11 shows a flow chart of a method 400 for tracking the position of the two user items 67a, 67b.

At a first step 402, the images 29a, 29b, 29c are received from the cameras 27a, 27b, 27c, in a similar manner to that described above.

At a second step 404, the images 29a, 29b, 29c are processed to split them into separate images for each of the zones 77a, 77b. This then creates a pair of images for each zone at each time instant.

At a third step 406, the images for each zone are processed to determine the position of the user object 67a, 67b in each zone 77a, 77b. This is done in a similar manner as discussed above. Therefore, the position of each object at each time instance can be determined.

At a further step 408, the position on the surface 3 at which the virtual projectile 75 is projected is controlled based on the game rule file 57 and the determined position of the two user objects 67a, 67b. When the virtual projectile 75 coincides with the user objects 67a, 67b or the edge of the surface 1, the direction may change, or a point may be scored.

It will be appreciated that the method 400 shown in FIG. 11 may also be used to provide for separate menus at each end of the table (i.e. in different zones 77a, 77b). It will also be appreciated that the method of tracking virtual objects can be used with an infrared light or other types of light, and can be used with two cameras or multiple pairs of cameras.

Whilst the example discussed above discloses the use of two zones 77a, 77b and two objects 67 67b, it will be appreciated that the surface 3 can be divided into any number of zones, for tracking any number of objects. For example, the method could be used to track table football players, with a projected football.

In further embodiments, multiple objects may be tracked without splitting the gaming area into zones 77a, 77b. In this case, the objects must be identifiable from analysis of the image. For example, the objects may reflect different wavelengths of light, may have different markers, or may have different size or shape to allow the different objects to be distinguished. Alternatively, separate pairs of cameras 27 may be provided to track each object.

In at least some of the embodiments discussed above, the use of non-visible infrared light is described. This may be, for example, light having a wavelength of more than 850 nm. It will also be appreciated that the same effect can be achieved with any non-visible light, allowing visible light projection of display elements, and reducing interference from other visible light sources. Any visible light emitted by the non-visible light source is negligible and undetectable by the human eye.

Furthermore, the non-visible light may be broadband or narrowband. For example, the light sources 19 may be broadband, and the cameras 27a, 27b, 27c may be narrowband, only able to detect a particular band within the light emitted by the light sources 19. Conversely, the light source 19 may be narrowband and the cameras 27a, 27b, 27c may be broadband with the active range of the camera including at least some wavelengths emitted by the light sources 19 (for example able to detect all light with wavelength more than 850 nm).

Any reflective surface or marker may be selected to reflect broadband light or narrow band light, provided that the reflective surfaces reflect wavelengths emitted by the light source 19 and detected by the cameras 27a, 27b, 27c.

The light source shown in FIG. 2 is given by way of example only. Any suitable light source can be used, which provides even illumination over the gaming area. Furthermore, any suitable image processing that allows identification of the ball, projectile or other objects may be used. Any suitable type of camera 27a, 27b, 27c may be used. In one example, the cameras may be a machine vision camera, with a suitable infrared filter. In other examples, other types of cameras with suitable infrared filters maybe used. In yet further examples, the camera may comprise a detector arranged to detect infrared without requiring other wavelengths of light to be filtered. In one example, the cameras 27a, 27b, 27c may work with a frame rate (fps) of approximately 60 fps.

The sensor in the camera may be any suitable size, number of pixels and have any suitable pixel size. In one example, the detector may have a pixel array of 1920×1200 pixels, with a 3.4 micron pixel size.

Any suitable frame rate may be used. In some examples, the frame rate may be increased to 150 to 200 fps. This ensures more accurate tracking by increasing the effective sampling rate, and also mitigating any frames where the field of view of the camera 27a, 27b, 27c is blocked.

The cameras 27a, 27b, 27c may be provided in any suitable position that allows determination of the position of the ball, projectile or other objects in three dimensions from a pair of images. At least one of the cameras may be positioned above the plane of the surface 3, and at least one of the cameras may be outside the area of the surface 3.

What is claimed is:

1.-41. (canceled)

42. A tracking system arranged to track movement of a gaming token over a gaming area, wherein the gaming token moves over at least part of the gaming area during use, the tracking system comprising:
an infrared light source arranged to illuminate the gaming area with infrared light, wherein the gaming token is arranged to reflect infrared light;
two or more infrared cameras arranged to capture images of the gaming area; and
a processing system arranged to identify the gaming token in the captured images.

43. The tracking system of claim 42 wherein the processing system is arranged to:
identify a plurality of candidate objects in each captured image;
identify the position of each candidate object in two or more captured images in a time series; and
determine which of the candidate objects corresponds to the gaming token based on the change in position of the candidate objects.

44. The tracking system of claim 43, wherein the processing system is arranged to determine which of the candidate objects corresponds to the gaming token based on the change in position of the candidate objects by:
comparing the movement of the candidate objects to expected movement of the object; and
identifying the gaming token as the candidate which best matches the expected movement.

45. The tracking system of claim 44, wherein the expected behavior includes one or more of:
whether the gaming token is still or stationary;
the location of the gaming token;
an expected direction of movement relative to the area;
a speed of movement within a defined range;
an expected direction of movement from a previous position;
continuous movement along a path;
movement along a smooth trajectory;
movement along a straight line over a short period of time.

46. The tracking system of claim 42, wherein the gaming area comprises a portion of a region illuminated by the light source and a portion of the field of view of the cameras, and wherein the processing system ignores regions outside the gaming area.

47. The tracking system of claim 42, wherein the light source provides even illumination over the gaming area.

48. The tracking system of claim 42, wherein the light source is positioned centrally across a width of the gaming area, the width perpendicular to a longest dimension of the gaming area.

49. The tracking system of claim 42, wherein the light source comprises an elongate body having a plurality of light emitting elements arranged along a length of the body.

50. The tracking system of claim 49, wherein the length of the body is arranged parallel to a longest dimension of the gaming area.

51. The tracking system of claim 42, wherein the light source comprises a cover arranged to diffuse the light emitted by the source.

52. The tracking system of claim 42, wherein the gaming area comprises a gaming surface, the gaming surface made of a material that reflects infrared light less than the gaming token

53. The tracking system of claim 42 further comprising:
one or more light sources arranged to emit visible light to project visible patterns in the gaming area.

54. The tracking system of claim 53, wherein the visible patterns projected in the gaming area comprise a user interface and the processing system is arranged to cause control of the user interface based on the tracked position.

55. The tracking system of claim 42 wherein the gaming token is a projectile that passes between two or more players during play, the players at opposite ends of the longest dimension of the gaming area.

56. The tracking system of claim 42, wherein the gaming area is the surface of a table tennis table, and the gaming token is a table tennis ball.

57. A user interface control method comprising:
projecting a user interface onto a surface of a gaming area;
using two or more cameras to track the position of a physical object as it is moved over the surface by a user; and
causing control of the user interface based on the tracked position.

58. The method of claim 57, wherein different parts of the user interface are projected onto different parts of the surface, and wherein moving the physical object onto areas where a part of the user interface is projected causes interaction with that part of the interface.

59. The method of claim 57, wherein a predetermined movement causes selection with or interaction with a part of the user interface.

60. The method of claim 59, wherein a predefined movement in one or more of the x, y and z direction causes selection or interaction with a highlighted item in the user interface.

61. The method of claim 57, wherein the user interface is projected using light in first range of visible wavelengths, and the gaming surface is illuminated in second range of non-visible wavelengths, wherein the cameras are sensitive to light in the second range.
